(19) United States
(12) Patent Application Publication
(10) Pub. No.: US 2023/0060831 A1
(43) Pub. Date: Mar. 2, 2023

(54) INCINERATION-FRIENDLY ELASTOMERIC ARTICLE AND METHOD OF MANUFACTURING

(71) Applicant: SHEN WEI (USA) INC., Union City, CA (US)

(72) Inventors: Belle L. Chou, Union City, CA (US); Sisitha Sudarshana, Homagama (LK); Chanakee Lakshika Chathushani, Hokandara (LK); Samantha S. Chang, Union City, CA (US)

(21) Appl. No.: 17/461,841

(22) Filed: Aug. 30, 2021

(51) Int. Cl. A41D 31/18; A41D 19/00

(52) U.S. Cl. CPC A41D 31/18; A41D 19/0082; A41D 2400/52; A41D 2500/54

(57) ABSTRACT

The present invention generally relates to an incineration-friendly wearable article comprising an elastomeric polymer matrix composed of an inorganic material capable of efficiently able to reduce or eliminate flue gas emissions during incineration of the article, and a method of making the incineration-friendly wearable article containing the elastomeric polymer matrix containing the inorganic material. The inorganic material acts as a catalytic thermal oxidative material.

### FIELD OF THE INVENTION

The present invention relates to an article that can reduce or eliminate the emission of flue gases present during incineration of the article after disposal. The article comprises a formula capable of reducing carbon, nitrogen, sulphur and aromatic substances, thereby enhancing the eco-friendliness and the emission reduction from the article.

### BACKGROUND OF THE INVENTION

With the escalating efforts to reduce climate change risk, demands to reduce gaseous emissions during waste disposal are being sought after that are efficient, safe and low cost.

Annually, for example, due to the high consumption of elastomeric articles, such as disposable gloves, tons of glove waste are collected and are incinerated. These flue gas emissions include those that originate from any full or partial combustion source, thermal processes and process involving furnaces and incineration plants. Typically, incineration is the accepted method of waste disposal in clinical settings since waste generated from clinical settings cannot be recycled.

The emission of flue gases from incineration, typically include gases such as carbon monoxide, carbon dioxide, dioxins and furans, volatile organic chemicals, oxides of nitrogen NOₓ (for example NO, NO₂), and oxides of sulphur SOₓ (for example SO₂). During the incineration process of these articles, these aforementioned flue gases are not only known to release harmful gases into the atmosphere resulting in air pollution known to be damaging to ecosystems, but are also known to be major serious health hazards. Additionally, these flue gas emissions have been known to have an unpleasant odor.

The release of such hazardous flue gas has become so detrimental that federal and local governments are enforcing strict efforts from industrial plants and demanding significant reduction of these harmful gases into the atmosphere.

Considerable attention has been sought after in recent years to reduce the concentration of NOx with nitrogen-based reducing agents. Methods have included removing the toxic flue gas products after emission. With regard to NOx, typically, these methods involve contacting NOx with ozone oxidizing them to higher nitrogen oxides and removing these higher oxides from the gas stream by aqueous scrubbers. With respect to sulphur dioxide, typically, SOx are removed by dry desulphurization.

Similarly, methods have been directed to reduce the formation of toxic chlorinated organics such as dioxins (polychlorinated dibenzodioxin and furans (polychlorinated dibenzofuran). Typically, wet or dry scrubbers have been used. Alternatives have been used to control temperature, carbon monoxide, oxygen and waste feed moisture which have been shown to be related to the formation of dioxins and furans and can be minimized. Other common methods have included, particulate filtration and dry ash formation. However, there are disadvantages, since it is time consuming to continually monitor and regulate the combustion of these wastes.

Other methods have been directed to prevent or minimize toxic flue gas emission formation. Typically, with respect to incineration of articles such as rubber gloves made with nitrile, for example, which are known to have lower emission values (less volatile organic chemicals), it has been shown that these articles contain compounds such as mercaptans, that contain sulphur, which not only have high levels of flue gas emissions, but can also produce unpleasant odors during the incineration process. Several approaches have been directed toward increasing acrylonitrile (ACN) contents in the article being incinerated, thereby reducing the volatile constituents which can lead to reduce emission of VOC reduction. However, there are disadvantages. Increasing the acrylonitrile content in a vulcanite can lead to an increase of NOx emissions during the incineration process. Additionally, many of the aforementioned methods, especially pertaining to vulcanites, typically contain at least one or more crosslinkers that usually contain sulphur or sulphur derivatives for better crosslinking.

Other approaches have included methods to absorb carbon dioxide, comprising a liquid on an aqueous oligomeric material functionalized with one or more groups that have an affinity for carbon dioxide (CO₂) and can reversibly react with CO₂. Typically, the oligomeric material comprises functional groups of silicones or amines of ketones or carbonates.

Recently, methods have been directed to control NOx emission of tail gas with NOx and NOx precursors. Typically, these are added to combustor, requiring extra steps. Other methods have incorporated ruthenium containing adsorbents to adsorb NOx. Typically, the adsorbent material comprises inorganic oxides, such as alumina, silica, zirconia, titania or mixed oxides coated with a platinum (Pt) metal. There are disadvantages with this method since Ru material are not readily available and may not be cost effective in long term production. Further, the adsorption followed by desorption of NOx typically will not reduce the net NOx emission into the environment. Furthermore, flue gas emission effectiveness is known to be dependent on storage capacity of the adsorbent, can not only be time consuming and requires continuous monitoring of the capacity of adsorption into the material, but also not cost efficient, since it requires application on substrate at high temperatures.

Other methods have included techniques such as solvent extraction, fractional distillation, steam stripping, biological degradation with hydrocarbons absorbed by the rubber. However these extra procedural steps can be costly and time consuming.

However, there are disadvantages associated with these aforementioned treatments. The collection of these toxic flue gas emissions typically utilizes sophisticated equipment, which can be expensive. Further disadvantages include the time and cost required for constant monitoring and extra steps.

Thus, although the above-mentioned processes can treat flue gaseous emissions, they can be time consuming and costly to continuously sustain over time. There is a need to reduce or eliminate NOx, and sulphur without limiting to VOC, NOx and SOx. Additionally, it would great to have a low emission material for product development that does not include sulphur derivatives in the formula during crosslinking that is capable of reducing toxic flue emission during incineration of the product or article itself.

Recently, more efficient efforts to reduce or eliminate flue gas emissions during disposal and incineration of articles have been sought after. These approaches have been directed towards developing eco-friendly products by incorporating materials or products such as agents and cross linkers, in for example, plastic or rubber gloves. However, these products have not been seen to efficiently be able to reduce or eliminate toxic gas emission during incineration of the product resulting in flue gas emission into the atmosphere.

Use of incinerators for waste management can be controversial, due to hazardous flue gas emissions, however, there are tremendous advantages, due to the ability of incineration plants to generate electricity and heat. Incinerators and other waste-to-energy plants can generate at least partially biomass-based renewable energy that offsets greenhouse gas pollution from coal, oil and gas fired power plants, which makes these methods particularly attractive.

For the foregoing reasons, there exists a need to find a solution to treat flue gaseous emissions that are present from disposing elastomeric articles during incineration that are efficient, low cost, safe and effective.

These features, advantages and other embodiments of the present invention are further made apparent, in the remainder of the present description, appended claims and drawings, to those of ordinary skill in the art.

### SUMMARY

The present invention is directed to an incineration-friendly wearable article and a method of making. According to an embodiment of the present invention, the incineration-friendly wearable article comprises an elastomeric polymer matrix composed of an inorganic material which does not include carbon, nitrogen and sulphur components in the chemical structure.

It is an object of the present invention to promote the proper disposal of wastes through incineration by substantially reducing, preventing the formation or eliminating highly toxic flue gas emissions which are known to create air pollution and health hazards.

According to an embodiment of the present invention, the incineration-friendly wearable article is an elastomeric article comprising an elastomeric material. Preferably, the elastomeric material is selected from the group consisting of vinyl, acrylonitrile, natural rubber latex, polyvinyl chloride, polyurethane, chloroprene, neoprene, synthetic polyisoprene rubber, silicon emulsion, and butadiene.

According to an embodiment of the present invention, the inorganic material can be selected from the group consisting of ceramic powder, zeolite, aluminum silicate, kaolin and any other inorganic material known to those skilled in the art which does not consist of C, N, or S.

In an embodiment of the present invention, a method for making an incineration-friendly wearable article is provided; the method comprising the steps of: a) providing a mold of the article; b) dipping the mold into the coagulant dipping system; c) drying; d) dipping in an elastomeric polymer matrix, forming an elastomeric layer, whereby the elastomeric polymer matrix comprises an inorganic material; e) curing the elastomeric layer; and f) leaching the elastomeric layer with hot water and g) drying the elastomeric layer to form the incineration-friendly wearable article.

In yet another embodiment of the present invention, any coating treatment used in the glove industry by those skilled in the art, can be used, for example, polymer coating, chlorination, donning coating, etc.

According to an embodiment of the present invention, the elastomeric polymer matrix can be vinyl, acrylonitrile, natural rubber latex, polyvinyl chloride, polyurethane, chloroprene, neoprene, synthetic polyisoprene rubber, silicon emulsion, and butadiene.

In an embodiment of the present invention, the drying steps occur at a temperature from about 60° C. to about 80° C.

In accordance with an embodiment of the present invention, the curing step is at a temperature between about 100° C. to about 110° C.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 illustrates a structure of an incineration-friendly wearable article having an outside surface and inside surface; according to an embodiment of the present invention.

FIG. 2 illustrates a method of making an incineration-friendly wearable article, according to an embodiment of the present invention.

FIG. 3 illustrates an example of CO, NOx and SOx emission results for the tested samples at 7% oxygen level; according to an embodiment of the present invention.

FIG. 4 illustrates an example of SOx emission results in ppm for the tested samples at 920° C. at 7% oxygen level; according to an embodiment of the present invention.

FIG. 5 illustrates an example of TVOC emission results in ppm for the tested samples at 920° C. at 7% oxygen level; according to an embodiment of the present invention.

FIG. 6 illustrates an example of TVOC emission results with respect to temperature; according to an embodiment of the present invention.

FIG. 7 illustrates an example of CO₂ emission data in ppm for the tested samples at 920° C. at 7% oxygen level; according to an embodiment of the present invention.

These and other features, aspects, and advantages of the present invention will become better understood with reference to the following description.

### DETAILED DESCRIPTION OF EMBODIMENTS

The description and the drawings of the present disclosure focuses on one or more preferred embodiments of the present invention, and describe exemplary optional features and/or alternative embodiments of the present invention. The description and drawings are for the purpose of illustration and not limitation. Those of ordinary skill in the art would recognize variations, modifications and alternatives which are also within the scope of the invention.

The present invention addresses the aforementioned need for the reduction of flue gases during incineration from a disposed article. In the descriptions presented below, the present invention generally relates to an incineration-friendly wearable article comprising an inorganic material capable of efficiently able to reduce or eliminate flue gas emission during incineration of the article, and a method of making the incineration-friendly wearable article containing the inorganic material.

The present invention is directed to an incineration-friendly wearable article and a method of making. According to an embodiment of the present invention, the incineration-friendly wearable article comprises an elastomeric polymer matrix composed of an inorganic material which does not include carbon, nitrogen and sulphur components in the chemical structure.

As used herein, the term “article” refers to an article that is incineration-friendly. It is known to those skilled in the art that the term “eco-friendly” or “incineration-friendly” refers to products that do not harm the environment whether in production, use or disposal, and is biodegradable.

Preferably, the article of the present invention is made of an elastomeric polymeric material typically comprising zinc oxide, potassium hydroxide and an elastomeric polymer matrix comprising an inorganic material; where the inorganic material does not include carbon, nitrogen, sulphur or aromatic constituents in its chemical structure. Further, in a preferred embodiment, the article does not contain any sulphur or sulphur containing materials, or any additives such as crosslinkers, accelerators, antioxidants, etc.

Typically, the inorganic material is capable of reducing the amount of elastomeric polymeric material component. The amount of C, N, aromatic substitutes and S, which adding to the article from polymer will reduce due to the usage of inorganic material. Those C, N, and S lead to more flue gas with CO₂, CO, VOC, SOx and NOx. present in the article, from about 10% to about 80%. Furthermore, according to a preferred embodiment of the present invention, the proposed elastomeric material can be produced without any crosslinkers, organic accelerators, antioxidants, aromatic and aliphatic based surfactants, or any other organic additives. More preferably, the elastomeric polymer matrix composed with an inorganic material which does not include, carbon, nitrogen and sulphur components in the chemical structure acts as an incineration friendly elastomeric article by reducing flue gas emission to the environment.

The elastomeric article of the present invention can include but not be limited to articles such as hoses, grommets, seals, gloves or any other elastomeric products known to those skilled in the art that can be made of synthetic or natural rubber, where the waste of these aforementioned article would go to incineration after disposal. Typically, during incineration, carbon, nitrogen, sulphur and other components in the article, tend to emit as CO, CO₂, NOₓ, Total Volatile Carbons (TVOC), dioxins, furans, carcinogenic substances with heavy metals and SOₓ.

In a most preferred embodiment of the present invention, the elastomeric article comprises and introduces the use of an inorganic material which also acts as a catalytic thermal oxidative material.

Typically, at incineration temperatures, such as temperatures above 500° C., the thermal catalytic material function as an oxidative catalyst and oxidizes the volatile organic matters to nontoxic gases.

In another preferred embodiments of the present invention, the advantage is low emissions of dioxins, furans, CO, SOx and NOx due to the reduction of C, N, and S content from the source itself in the elastomeric polymer, irrespective of the temperature, oxygen levels or the type of fuel used. Preferably, by allocating a less amount of material to burn or incinerate, the emissions will decrease significantly.

In an embodiment of the present invention, the inorganic material used will compensate the polymer without altering the mechanical and chemical properties compared to a regular elastomeric article known to those skilled in the art. Preferably, the polymer content of the of the elastomeric article will reduce by using the inorganic material, but will not affect the properties of the final article. During a typically incineration the elastomeric article according to an embodiment of the present invention, the article will produce CO, CO₂, and insignificant amount of NOx and TVOC. Preferably, 80% of reduction of TVOC and NOx can be achieved by using the optimized formulation of the present invention, when compared to the regular formulations. Also, the proposed method will reduce the SOx emission when compared to the regular elastomeric material.

Typically, according to an embodiment of the present invention, the formation of gases during incineration happens by subjecting the components present within the elastomeric article to thermal energy, thus reacting the components present within the article. More preferably, the proposed product contains reduced number of organic materials without any aromatic components itself. According to a preferred embodiment of the present invention, during exposure to thermal energy, the components in the elastomeric polymer material tend to vibrate and attach with the oxygen while breaking the chemical and mechanical bonding (due to the thermal energy which affects the C, N, and other chemical components in the polymer to break their bonds in between them and cause their oxidation, resulting in emission of gases such as CO, CO₂, VOC, NOx, etc.).

In an embodiment of the present invention, it does not require any additional processes for emission reduction, hence no additional cost or method for the flue gas purification. Preferably, the proposed elastomeric article is incineration friendly and is effective in reducing of all flue gas emissions, without limiting to a specific gas.

Referring now to Table 05, total volatile organic matters are reduced with increasing temperature and is inversely proportional to the content of inorganic material present in the elastomeric article. According to the obtained results, the inorganic material acts as a thermal catalytic oxidizer at incineration temperatures above 500° C., thereby reducing the volatile organic matters present within the elastomeric article by converting the inorganic material to non-toxic gases.

In yet another embodiment of the present invention, the function of the invention is to reduce flue gas emissions such as CO, CO₂, SOx, NOx, dioxin and furans, total volatile carbons, carcinogenic substances such as heavy metals from the article itself, during incineration by reducing the organic materials present within the article itself.

Typically, during incineration, combustion typically occurs in incinerator vessels, where organic materials comprising of carbon, hydrogen nitrogen and aromatic constituents tend to oxidize in the presence of heat or fuel. Flue gas emissions typically occur during the continual oxidation and reduction process of the organic materials. By eliminating accelerators, antioxidants, vulcanizing agents, and/or any other additives, the total amount of carbon, nitrogen and sulphur contents of the desired elastomeric article is reduced; hence reducing the total flue gas emissions during incineration. According to an embodiment of the present invention, the reduction of the above referenced additives does not negatively impact the chemical and physical integrity and performance of the elastomeric article itself, such as tensile strength, elongation, puncture resistance, abrasion resistance and thickness.

In a most preferred embodiment of the present invention, flue gas reduction using an inorganic material is built into the incineration-friendly wearable article itself, eliminating the need of a complex post-treatment process for the flue gas emissions. The present invention focuses to reduce the flue gas emission from the article source itself, during incineration, rather than using a complex downstream process thus avoiding additional and costly supplies required.

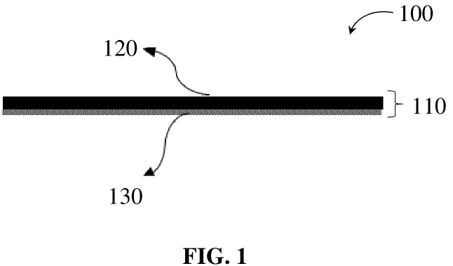

Referring now to FIG. 1, a structure of a preferred embodiment of the present invention, an incineration-friendly wearable article 100 includes at least a layer 110 having an outside surface 120 and inside surface 130 is provided. The inside surface 130 refers to a surface of the article that can be a proximal to the wearer or faces the wearer’s skin when worn by a user. The outside surface 120 refers to the surface of the incineration-friendly wearable article 100 that can be distal to or faces the external environment from the wearer. Typically, the layer 110 can be made from any polymer elastomeric material known to those skilled in the art. Preferably, the polymeric elastomeric material comprises an elastomeric polymer matrix. Preferably, the elastomeric polymer matrix comprises a dispersion of inorganic material that can be directly added to the polymeric compound and can be formed as a single layer with the incineration-friendly characteristic.

In yet another embodiment of the present invention, an incineration-friendly wearable article is provided. This article 100 typically comprises an elastomeric polymer matrix composed of an inorganic material capable of efficiently able to reduce or eliminate flue gas emission during incineration of the article. Typically, the inorganic material comprises catalytic thermal oxidative material, and does not include carbon, nitrogen and sulphur components in the chemical structure of the inorganic material.

Typically, the inorganic material is capable of reducing the amount of polymeric material component present in the elastomer, from about 10% to about 80%. Less than 10% can be used, however the reduction in flue gas emissions during incineration may not be as significant. Greater than 80% of inorganic material may have a tendency to affect the elastomeric properties of the article. Furthermore, in a preferred embodiment of the present invention, the proposed elastomeric material can be produced without any crosslinkers, organic accelerators, antioxidants, aromatic and aliphatic based surfactants, or any other organic additives. More preferably, the elastomeric polymer matrix composed with an inorganic material which does not include, carbon, nitrogen and sulphur components in the chemical structure acts as an incineration friendly elastomeric article capable of facilitating the reduction flue gas emission to the environment.

In an embodiment of the present invention, FIG. 1 illustrates an example of an incineration-friendly wearable article, for example an elastomeric article such as a disposable glove undergoing incineration.

Typically, the incineration-friendly wearable article 100 can be an elastomeric article and may include but are not limited to gloves, diapers, films, sheets, bandages, condoms, incontinence devices and other personal skin protective articles. For example, the disposable gloves/articles include single-use, fluid-impermeable, protective examination gloves/articles. The elastomeric article can be made of an elastomeric material selected from a group consisting of vinyl, acrylonitrile, natural rubber latex, polyvinyl chloride, polyurethane, chloroprene, neoprene, synthetic polyisoprene rubber, silicon emulsion, and butadiene.

In yet another embodiment of the present invention, the incineration-friendly wearable article can be invertible.

In a preferred method of the present invention, the inorganic material function as an oxidative catalyst and is temperature dependent on the temperatures used by incinerators known to those skilled in the art. Preferably, the incineration of the elastomeric article is accomplished at temperatures above 500° C., thereby converting volatile organic matters in the incineration emissions into nontoxic gas components. More preferably, the temperature is at least 480° C.

In a preferred embodiment of the present invention, the formulation of the invertible elastomeric article is designed to minimize toxic emissions such as carbon monoxide, NOx, SOx, dioxins and furans by eliminating the use of rubber accelerators, sulphur and chlorine.

In yet another embodiment of the present invention, the article can further comprise an inside surface donning coating, treated with the inorganic complex.

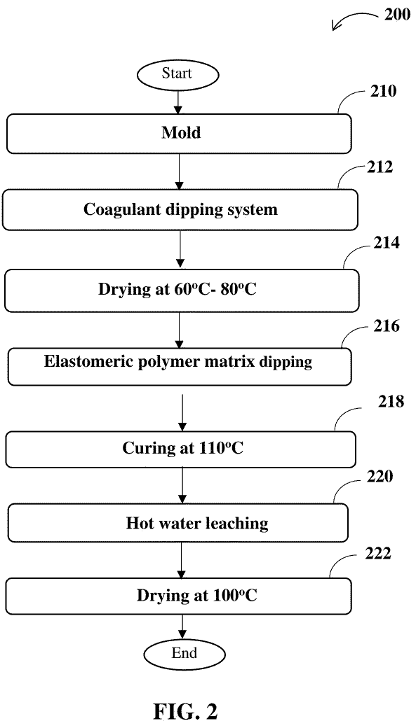

In accordance with an embodiment of the present invention, a method 200 of making an incineration-friendly wearable article is illustrated in FIG. 2. First a mold of the article is provided 210 and dipped into a coagulant dipping system 212 with an immersion time of preferably 12 seconds, followed by a dwell time of 10 seconds; followed by withdrawal time of 15 seconds. The coagulant dipping system comprises any coagulant agent known to those skilled in the art, for example, calcium chloride CaCl₂.

In accordance with the present invention, preferably, the incineration-friendly wearable article is an elastomeric article. The article was made using the coagulant system according to chemical composition in Table 1, gave a thickness of 0.02 mm, which had poor stretchability.

Next, according to a preferred embodiment of the present invention, the mold is dried 214 at a temperature from about 60° C. to about 80° C. for about 10 minutes after dipping 212 in coagulant dipping system, and then immersed by dipping into an elastomeric polymer matrix comprising an inorganic material 216. Preferably, the elastomeric polymer matrix of the incineration friendly elastomeric article comprises the formulation illustrated in Table 1. More preferably the elastomeric polymer matrix comprises an inorganic material capable of reducing or eliminating flue gas emission during incineration of the article. In yet another embodiment of the present invention, this is a single dip.

Typically, the elastomeric polymer matrix does not contain additives, accelerators, ZDEC (Zinc diethyl dithiocarbamate), antioxidants, sulphur and other additives.

According to an embodiment of the present invention, the application of a donning coat is optional, since the donning coating does not contain inorganic material to reduce flue gas emission.

In yet an alternative embodiment of the present invention, the articles can be dried from about 60° C. to about 80° C. for about 20 minutes.

Table 1

Preferred formulation for the Incineration friendly elastomeric article

| Material | Dry Qty/Phr |
|---|---|
| Nitrile latex | 100.000 |
| KOH | 0.800 |
| ZnO | 1.000 |
| Inorganic material | 25.000 |
| Pigment | 0.010 |
| Total | 126.81 |

In an embodiment of the present invention, the elastomeric article is then cured 218 at a temperature of about 110±2° C. According to an embodiment of the present invention, the incineration-friendly article can be obtained from a single dip, because the inorganic material which acts as an oxidative thermal catalyst is in the compound used to make the elastomeric article. Preferably, the inorganic material is present throughout the entire article without limited to a specific layer. At this temperature polymer crosslinking can occur forming a cured elastomeric article. Next, the outside surface of the cured elastomeric article can then be placed in a hot water leaching system 220 for about 1-2 minutes to remove excess coagulant, if present, followed by drying the article 222 at about 100° C. to obtain the finished incineration-friendly wearable article.

In the most preferred embodiment of the present invention, the finished incineration-friendly wearable article contains an inorganic material which acts as a catalytic thermal oxidizer and oxidize the volatile organic matters above 500° C.

More preferably, the present invention contains the inorganic material from about 10% to about 80% in the elastomeric article by reducing the flue gas emission itself during incineration, without changing the physical performance of the elastomeric article.

The embodiments of the present invention have numerous advantages. Formulation of the present invention does not cause health hazards and no negative environmental impact, as it reduces the toxic flue gas emissions during incineration of the article.

The proposed formula with the inorganic material in the elastomeric article specifically oxidizes volatile organic matters and reduce the volatile organic matter emissions significantly at temperatures above 500° C.

Further, according to an embodiment, the product formula of the present invention considers reduction of overall flue gases without limiting to a specific gas. According to an embodiment, the present invention is not specific to CO₂, or NOx or SOx or VOC, etc. Preferably, as used herein, “overall” means the reduction of all flue gasses which contain the aforementioned gases.

Further during the incineration process, It is not required to have any additional gas purification system or scrubbers, hence the proposed product formula is able to reduce the overall gas emission.

The product formulas in Table 1 and Table 2 do not lead to toxic emissions such as dioxin and furans, which can cause critical health hazards. Additionally, the reduction of all possible volatile organic matters can be obtained through the current invention by the product itself.

The present invention is able to avoid emissions of carcinogenic substances such as heavy metals in flue gas emission during incineration.

In a further embodiment of the present invention, the overall reduction in emission and toxic components from the formulation itself during incineration not only benefit the huge waste management processors, but can used and favors small scale waste management processes which typically cannot reach high temperatures or are not equipped with advanced gas purification systems.

In an embodiment of the present invention, similar results can be obtained by changing the proportion of the components in the material (Tables 2 and 4).

In yet another embodiment of the present invention, the same results can be obtained by changing the total solid content in the elastomeric formulation.

In yet another embodiment of the present invention, different inorganic material can be used which are carbon, nitrogen and sulphur free, and can be used to obtain the same characteristics on flue gas emission during incineration of the elastomeric article.

In a preferred embodiment of the present invention, the sequence of adding the material can be changed and can provide the same advantages of the current invention. Preferably, the materials described in Table 02 should be added in that order. Typically, according to an embodiment of the present invention, the order of material can be modified, for example, latex, KOH, pigment, ZnO and inorganic material or so forth.

The invention can be used on any other article or form, not limiting to the elastomeric articles. According to an embodiment of the present invention, the article is not just be limited to an elastomeric articles, but can be used on any other article known to those skilled in the art that emit flue gas during incineration.

Still further in another embodiment of the present invention, two or more inorganic materials can be used, whereby the inorganic material is free of carbon, nitrogen and sulphur, to obtain the reduction of flue gases during incineration as per the formula described in Table 2. Preferably, the inorganic materials of the present invention can be selected from the group consisting of ceramic powder, zeolite, aluminum silicate, kaolin and any other inorganic material known to those skilled in the art which does not consist of C, N, or S.

According to an embodiment of the present invention, the coagulant dipping system typically does not have the inorganic material. Preferably, the coagulant dipping system comprises materials known to those skilled in the art, such as, for example, calcium chloride CaCl₂.

Table 2

The chemical formulation of Example 02

| Material | Dry Qty/phr |
|---|---|
| Nitrile latex | 100.000 |
| KOH | 0.800 |
| ZnO | 1.000 |
| Inorganic material A | 15.000 |
| Inorganic material B | 10.000 |
| Pigment | 0.010 |
| Total | 126.81 |

Preferably the inorganic material is embedded within the elastomeric polymer matrix and inside the surface of the article and is then stripped off from the mold.

In yet another embodiment of the present invention, flue gas emission results of four different sample articles made by the method described in the present invention are shown in Tables, 3, 5, 6 and 8 respectively with various formulations. According to the obtained results, extreme levels of flue gas emissions can be seen in regular formulation with increasing the organic content of the articles resulting in extreme flue gas emission. The organic content increased with respect to the content of the accelerators and other additives. By comparing, samples 01, 02, 03 and 04; sample 02 was prepared according to the most preferred elastomeric polymer matrix formulation resulting in the lowest flue gas emission. According to the he most preferred embodiment of the present invention, the product formulation resulting in the lowest flue gas emission during incineration can be seen in Table 3.

Table 3

Flue gas emission results for the best formula (sample 02) in Table 01

| | | | |
|---|---|---|---|
| Parameter | Unit | At 920° C. | At 750° C. |
| CO | ppm | 0.08 | 0.26 |
| CO₂ | % | 1.389 | 1.333 |
| NOx as NO₂ | ppm | 0.56 | 0.856 |
| SOₓ | ppm | <0.03 | 0.049 |
| TVOC | ppm | 2.47 | 6.015 |
| Dioxin and Furans | mg/NM3 | Not detected | Not detected |

Table 4

Chemical formulations of tested materials

| Chemical Name | Dry Quantity | | | |
|---|---|---|---|---|
| | Sample 01 | Sample 02 | Sample 03 | Sample 04 |
| Nitrile latex | 100.000 | 100.000 | 100.000 | 100.000 |
| KOH | 0.800 | 0.800 | 0.800 | 0.800 |
| Sulphur | 1.200 | | | |
| ZnO | 1.400 | 1.000 | 1.000 | 1.000 |
| Accelerators | 0.800 | | | 0.800 |
| Pigment | 0.400 | 0.010 | 0.010 | 0.010 |
| Inorganic Material | | 25.000 | 10.000 | 10.000 |

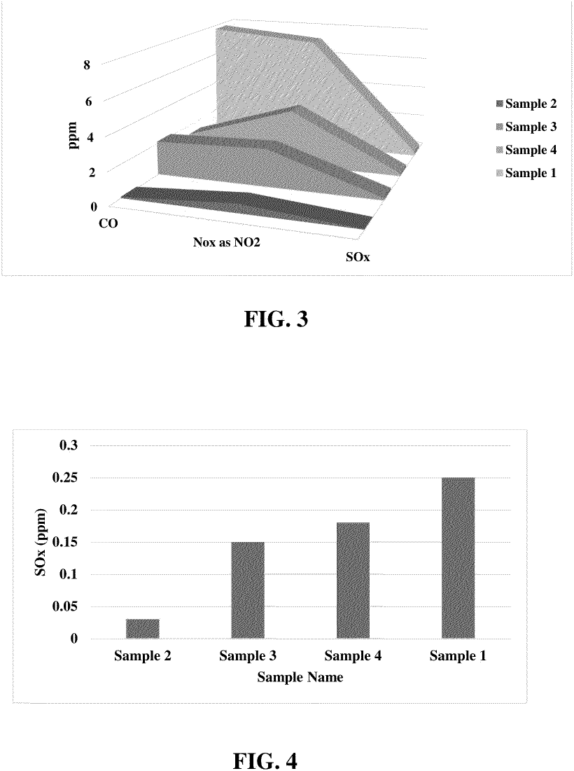

According to an embodiment of the present invention, each of elastomeric articles prepared in samples 1-4 were tested for flue gas emissions, and the results are seen in FIGS. 3-7.

Referring now, FIG. 3 illustrates an example of CO, NOx and SOx emission results for four test samples according to the elastomeric polymer matrix formulations of the present invention, at 7% oxygen level.

According to an embodiment of the present invention, FIG. 4 illustrates an example of SOx emission results in ppm for the tested samples 1-4, at 920° C. and at 7% oxygen level. The preferred formulation from Sample 2 illustrates the most preferred formulation showing the least emissions of SOx.

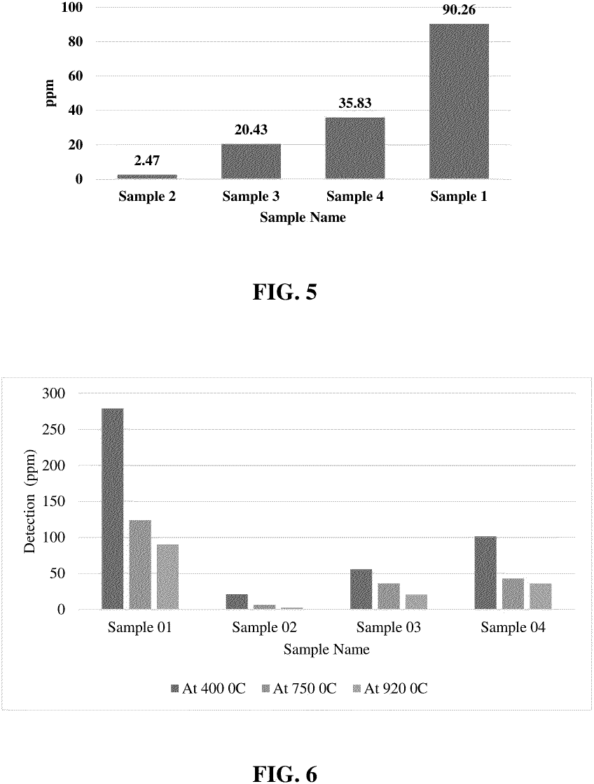

Similar results can be seen in FIG. 5 which illustrates an example of TVOC emission results in ppm for the tested samples at 920° C. at 7% oxygen level. Again, test sample 2 with the elastomeric polymeric matrix comprising the most preferred formulation of inorganic material according to the present invention, shows the lowest TVOC (ppm) emissions compared to other samples containing organic materials.

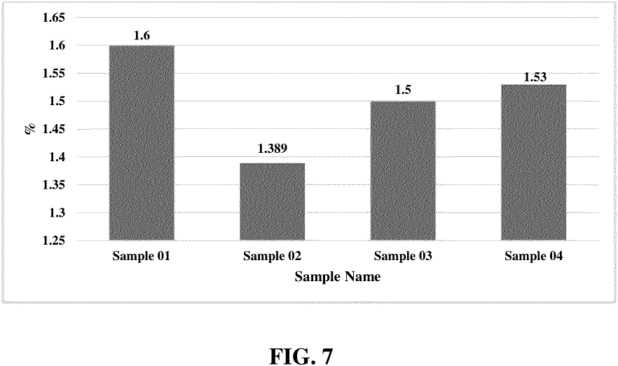

Accordingly, referring now to FIG. 6 and Table 5, examples of TVOC emission (ppm) results comparing samples 1-4 with respect to varying incineration temperatures, 400° C., 750° C. and 920° C. According to the most preferred embodiment of the present invention, the formulation of sample 2 again showed the lowest levels of TVOC (ppm) emissions at each temperature respectively.

Table 5

TVOC results comparison of the samples with respect to the temperature

| Sample No | TVOC (ppm) | | |
|---|---|---|---|
| | At 400° C. | At 750° C. | At 920° C. |
| Sample 01 | 278.725 | 123.760 | 90.260 |
| Sample 02 | 20.891 | 6.015 | 2.470 |
| Sample 03 | 55.683 | 35.841 | 20.432 |
| Sample 04 | 101.283 | 42.512 | 35.831 |

Referring now to FIG. 7, an example of CO₂ emission data in ppm for tested samples 1-4 are shown at 920° C. at 7% oxygen level, according to an embodiment of the present invention. Again, the formulation of sample 2, prepared according to the most preferred embodiment of the present invention showed the lowest level of CO₂ emission (1.389 ppm).

According to yet other embodiments of the present invention, Tables 6, 7 and 8 illustrate flue gas emission for Samples 1, 3 and 4 accordingly made according to the formulations in Table 4 at 920° C. at 7% oxygen level.

Table 6

Flue gas emission for sample 01 in Table 4, °C at 7 % of oxygen level

| Parameter | Unit | At 920° C. | At 750° C. |
|---|---|---|---|
| CO | ppm | 7.75 | 9.25 |
| CO₂ | % | 1.6 | 1.52 |
| NOx as NO₂ | ppm | 7.18 | 8.94 |
| SOx | ppm | 0.25 | 0.36 |
| TVOC | ppm | 90.26 | 123.76 |
| Dioxin and Furans | mg/NM3 | 0.052 | 0.074 |

Table 7

Flue gas emission for the sample 03, 920° C. at 7 % of oxygen level

| Parameter | Unit | At 920° C. | At 750° C. |
|---|---|---|---|
| CO | ppm | 2.1 | 2.707 |
| CO₂ | % | 1.5 | 1.456 |
| NOx as NO₂ | ppm | 2.34 | 3.454 |
| SOₓ | ppm | 0.15 | 0.238 |
| TVOC | ppm | 20.43 | 35.841 |
| Dioxin and Furans | mg/NM3 | 0.024 | 0.043 |

Table 8

Flue gas testing results for sample 04 920° C. at 7 % of oxygen level

| Parameter | Unit | At 920° C. | At 750° C. |
|---|---|---|---|
| CO | ppm | 1.35 | 1.943 |
| CO₂ | % | 1.53 | 1.463 |
| NOx as NO₂ | ppm | 3.53 | 3.491 |
| SOₓ | ppm | 0.18 | 0.252 |
| TVOC | ppm | 35.83 | 42.512 |
| Dioxin and Furans | mg/NM3 | 0.031 | 0.041 |

Referring to Table 9 shows the lead (Pb) content from each of the elastomeric articles with the formulations from samples 1, 2, 3, and 4 according to an embodiment of the present invention. Sample 2 which comprises the most preferred elastomeric polymer matrix formulation of the present invention, displayed no detection of Pb (ppb), compared with other samples 1, 3, and 4.

Table 9

Pb content of the tested materials

| | | | | |
|---|---|---|---|---|
| Sample Name | Sample 01 | Sample 02 | Sample 03 | Sample 04 |
| Pb (ppb) | 2.5 * 10⁻⁵ | ND | 1.5 *10 ⁻⁶ | 1.9 * 10⁻⁶ |

According to an embodiment of the present invention, the article having the said functional benefit (sample 2) did not exhibit significant alterations in mechanical properties such as unaged and aged tensile and abrasion (Tables 10 and 11). Furthermore, after aging for seven days at 70° C. tensile properties remained unchanged.

Table 10

Unaged tensile property test data of Sample 02
Test Standard - ASTM D 412

| Sample replicates | Article thickness (mm) | Tensile strength (MPa) | Elongation at Break (%) |
|---|---|---|---|
| 1 | 0.13 | 27.66 | 710.00 |
| 2 | 0.13 | 33.31 | 672.00 |
| 3 | 0.13 | 30.87 | 598.00 |
| 4 | 0.13 | 31.22 | 701.00 |
| 5 | 0.13 | 31.84 | 695.00 |
| 6 | 0.13 | 31.83 | 588.00 |
| Min | 0.13 | 27.66 | 588.00 |
| Max | 0.13 | 33.31 | 710.00 |
| Average | 0.13 | 31.12 | 660.67 |

Table 11

Aged tensile property test data of Sample 02
Test Standard - ASTM D 412

| Sample replicates | Article thickness (mm) | Tensile strength (Mpa) | Elongation at Break (%) |
|---|---|---|---|
| 1 | 0.13 | 37.20 | 640 |
| 2 | 0.13 | 35.14 | 582 |
| 3 | 0.13 | 36.12 | 448 |
| 4 | 0.13 | 34.91 | 628 |
| 5 | 0.13 | 34.31 | 593 |
| 6 | 0.13 | 38.01 | 458 |
| Min | 0.13 | 34.31 | 448 |
| Max | 0.13 | 38.01 | 640 |
| Average | 0.13 | 35.95 | 558.17 |

Table 12

Abrasion test data of sample 02
Test Standard - ASTM D 3389
Type of wheel - H-18
Test load- 500 g

| Sample replicates | Article thickness (mm) | Breakthrough Cycles |
|---|---|---|
| 1 | 0.13 | >1000 |
| 2 | 0.13 | >1000 |
| 3 | 0.13 | >1000 |
| 4 | 0.13 | >1000 |
| Average | 0.13 | >1000 |

In summary, the present invention provides an incineration-friendly wearable article composed of an elastomeric polymer matrix having an inorganic material that is built into the article itself to facilitate incineration with reduced flue gas emission.

Further, this incineration-friendly wearable article having an inorganic material in its elastomeric polymer matrix, can help suppress flue gas emission from the article itself, at varying temperatures during incineration, thus potentially eliminating costly complex processing treatment.

Throughout the description and drawings, example embodiments are given with reference to specific configurations. It can be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. An incineration-friendly wearable article comprising an elastomeric polymer matrix comprising an inorganic material, wherein the article is prepared by dipping in a coagulant dipping system, the article comprising:
a multiple application of the elastomeric polymer matrix incorporating the inorganic material; and
wherein the inorganic material integrates into the article, thereby forming the incineration-friendly wearable article which reduces or eliminates toxic flue gas emissions during incineration of the article;
whereby the inorganic material acts as a catalytic thermal oxidative material capable of converting volatile organic matters formed during incineration emissions into non-toxic gas components.

2. The incineration-friendly wearable article of claim 1, wherein the inorganic material does not comprise carbon, nitrogen or sulphur.

3. The incineration-friendly wearable article of claim 1, wherein the incineration-friendly wearable article comprises an elastomeric material.

4. The incineration-friendly wearable article of claim 3, wherein the elastomeric material is selected from the group consisting of vinyl, acrylonitrile, natural rubber latex, polyvinyl chloride, polyurethane, chloroprene, neoprene, synthetic polyisoprene rubber, silicon emulsion and butadiene.

5. The incineration-friendly wearable article of claim 1, wherein the incineration-friendly wearable article is a disposable glove.

6. The incineration-friendly wearable article of claim 1, wherein incineration temperatures are at least 500° C.

7. The incineration-friendly wearable article of claim 2, wherein the inorganic material is selected from the group consisting of ceramic powder, zeolite, aluminum silicate, and kaolin.
